(19) United States
(12) Patent Application Publication
(10) Pub. No.: US 2024/0279250 A1
(43) Pub. Date: Aug. 22, 2024

(54) SINGLE-ION CONDUCTING NETWORK

(71) Applicant: Sumitomo Chemical Co., Ltd., Tokyo (JP)

(72) Inventors: Thomas Kugler, Godmanchester (GB); Antonio Attanzio, Godmanchester (GB)

(73) Assignee: Sumitomo Chemical Co., Ltd., Tokyo (JP)

(21) Appl. No.: 18/561,707

(22) PCT Filed: May 19, 2022
(86) PCT No.: PCT/EP2022/063633

§ 371 Date: Nov. 16, 2023

(30) Foreign Application Priority Data
May 19, 2021 (GB) 2107158.4

(51) Int. Cl. C07F 5/06; H01M 50/414

(52) U.S. Cl. CPC C07F 5/068; H01M 50/414

(57) ABSTRACT

A method of forming a single-ion conductive network comprising reaction of a first compound of formula (I) with a second compound and a third compound: formula (I). X is selected from the group consisting of B and Al. M⁺ is a cation, e.g. a lithium ion. The second compound comprises at least two hydroxyl groups, e.g. a diol. The third compound comprises only one hydroxyl group. The single-ion conductive network may be used in a metal battery or metal ion battery.

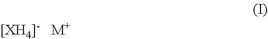

### BACKGROUND

Embodiments of the present disclosure relate to single-ion conducting materials, methods of making single ion conducting materials and batteries containing said single-ion conducting materials.

Single ion conducting networks are known.

WO 2020/072650 discloses an interfacial layer of an anode comprising an ion-conducting network having anionic coordination units, organic linkers bonded through the anionic coordination units and counterions dispersed in the ion-conductive organic network.

U.S. Pat. No. 10,665,896 discloses single ion conducting polymer network.

Zhenan Bao et al, “A Dynamic, Electrolyte-Blocking, and Single-Ion-Conductive Network for Stable Lithium-Metal Anodes” Joule, Volume 3, Issue 11, 20 Nov. 2019, Pages 2761-2776 discloses a single ion conductive network formed by reaction of lithium aluminium hydride, lithium borohydride or silicon tetrachloride with 1H,1H,11H,11H-perfluoro-3,6,9-trioxaundecane-1,11-diol (FTEG).

WO 2014/129972 discloses sp³ boron-based single-ion conductive polymers.

### SUMMARY

In some embodiments, the present disclosure provides a method of forming a single-ion conductive network comprising reaction of a first compound of formula (I) with a second compound and a third compound:

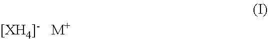

wherein:
X is selected from the group consisting of B and Al;
M⁺ is a cation;
the second compound comprises at least two hydroxyl groups; and
the third compound comprises only one hydroxyl group.

Optionally, M⁺ is Li⁺.

Optionally, the second compound is a compound of formula (II):

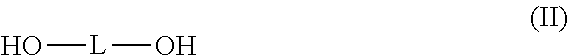

wherein L is a divalent organic group.

Optionally, the third compound is a compound of formula (III):

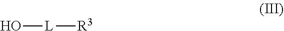

wherein L is a divalent organic group; and R³ is selected from F and H.

Optionally, L of formula (II) or formula (III) is a group of formula (IV):

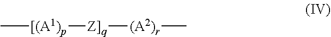

wherein:
A¹ and A² in each occurrence are independently selected from unsubstituted or substituted arylene; unsubstituted or substituted heteroarylene; and CR¹₂ wherein R¹ in each occurrence is H or a substituent;
q is 0 or a positive integer;
if q is a positive integer then p is at least 1; and
r is at least 1; and
Z in each occurrence is independently O, S, NR⁴, Si(R⁵)₂SO₂, CO C═O, COO or CONR⁴
wherein R⁴ in each occurrence is independently H or a substituent and R⁵ in each occurrence is a substituent.

Optionally, the hydroxyl groups of the second and third compounds are the only protic groups of these compounds.

Optionally, each R¹ is independently selected from the group consisting of:
H;
F;
a linear, branched or cyclic C₁₋₁₂ alkyl wherein one or more non-adjacent, non-terminal C atoms may be replaced with O or COO and one or more H atoms may be replaced by F;
an anionic group; and
a photocrosslinkable group.

Optionally, each R¹ is independently H or F.

Optionally, the second compound is a dihydric alcohol.

Optionally, the second compound is a compound of formula (IIa):

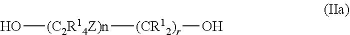

wherein R¹ in each occurrence is H or a substituent; n is at least 1; r is at least 1; and Z in each occurrence is independently O, S, NR⁴, Si(R⁵)₂SO₂, CO C═O, COO or CONR⁴ wherein R⁴ in each occurrence is independently H or a substituent and R⁵ in each occurrence is a substituent.

Optionally, the third compound is a compound of formula (IIIa):

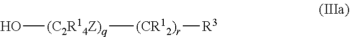

wherein:
R¹ in each occurrence is H or a substituent;
q is at least 1;
r is at least 1; and
Z in each occurrence is independently O, S, NR⁴, Si(R⁵)₂SO₂, CO C═O, COO or CONR⁴ wherein R⁴ in each occurrence is independently H or a substituent and R⁵ in each occurrence is a substituent.

Optionally, the second compound:third compound molar ratio is between 99:1-1:99.

In some embodiments, the present disclosure provides a single ion-conducting network obtainable by the method described herein.

In some embodiments, the present disclosure provides a single ion-conducting network comprising groups of formula (V):

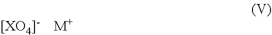

wherein: X is selected from Al and B; M⁺ is a cation; and wherein the single-ion conducting network includes groups of formula (V) wherein at least one of the O atoms is bound through an organic group L to an O atom of another group of formula (V) and at least one of the O atoms is bound to an organic group which is not bound to another group of formula (V).

Optionally, the single-ion conductive network further comprises groups of formula (V) in which each one of the O atoms of formula (V) groups is bound through an organic linking group L to an O atom of another group of formula (V); and

Optionally, the organic group which is not bound to another group of formula (V) is a group of formula (VI):

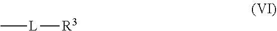

wherein R³ in each occurrence is independently H or F.

Optionally, the group L connected to O atoms of groups of formula (V) is a group of formula (IV):

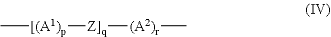

wherein:
A¹ and A² in each occurrence are independently selected from unsubstituted or substituted arylene; unsubstituted or substituted heteroarylene; and CR¹₂ wherein R¹ in each occurrence is H or a substituent;
q is 0 or a positive integer;
if q is a positive integer then p is at least 1;
r is at least 1; and
Z in each occurrence is independently O, S, NR⁴, Si(R⁵)₂SO₂, CO C═O, COO or CONR⁴
wherein R⁴ in each occurrence is independently H or a substituent and R⁵ in each occurrence is a substituent.

In some embodiments, the present disclosure provides a metal battery or metal ion battery comprising an anode, a cathode and a structure comprising a single-ion conducting network described herein disposed between the anode and cathode.

Optionally, the structure comprises the single-ion conducting network and an additional material dispersed in the single-ion conducting network.

The additional material may be selected according to desired mechanical properties of a composition comprising the single-ion conducting network and the additional material.

Optionally, the additional material is an organic polymer, for example a cellulose.

Optionally, an anode protection layer disposed between the anode and cathode comprises the single-ion conducting network.

In some embodiments, the present disclosure provides a method of forming a single-ion conductive network comprising reaction of a first compound of formula (VII) with a second compound and a third compound:

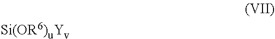

wherein R⁶ is an organic residue substituted with at least one group of formula -An⁻M⁺ wherein
An⁻ is an anionic group and M⁺ is a cation;
Y is a leaving group;
u is 1 or 2;
v is 4-u;
the second compound comprises at least two hydroxyl groups; and
the third compound comprises two or more hydroxyl groups.

A “single-ion conductive network” as described herein comprises a network of anions linked to one another through linking groups and free cations.

### DESCRIPTION OF DRAWINGS

FIG. 1 illustrates reactants for forming a single-ion conductive network according to some embodiments of the present disclosure;

FIG. 2A illustrates a product of a reaction of LiAlH₄ with a diol only;

FIG. 2B illustrates products of reactions of LiAlH₄ with a monohydric alcohol and a diol;

FIG. 3 is a schematic illustration of a battery having a separator comprising a single-ion conductive network as described herein; and

FIG. 4 is a schematic illustration of a battery having an anode protection layer comprising a single-ion conductive network as described herein.

The drawings are not drawn to scale and have various viewpoints and perspectives. The drawings are some implementations and examples. While the technology is amenable to various modifications and alternative forms, specific embodiments have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list. References to a layer “over” another layer when used in this application means that the layers may be in direct contact or one or more intervening layers are may be present. References to a layer “on” another layer when used in this application means that the layers are in direct contact.

The teachings of the technology provided herein can be applied to other systems, not necessarily the system described below. The elements and acts of the various examples described below can be combined to provide further implementations of the technology. Some alternative implementations of the technology may include not only additional elements to those implementations noted below, but also may include fewer elements.

These and other changes can be made to the technology in light of the following detailed description. While the description describes certain examples of the technology, and describes the best mode contemplated, no matter how detailed the description appears, the technology can be practiced in many ways. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms.

In the following description, for the purposes of explanation, numerous specific details are set forth in order to provide a thorough understanding of implementations of the disclosed technology. It will be apparent, however, to one skilled in the art that embodiments of the disclosed technology may be practiced without some of these specific details.

In some embodiments, the present disclosure provides a method of formation of a single-ion conductive network in which a first compound of formula (I) is reacted with a second compound and with a third compound:

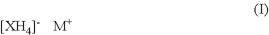

X is selected from the group consisting of Al and B.
M⁺ is a cation, preferably an alkali cation, more preferably Li⁺.

The second compound contains at least two hydroxyl groups

The third compound has a single hydroxyl group.

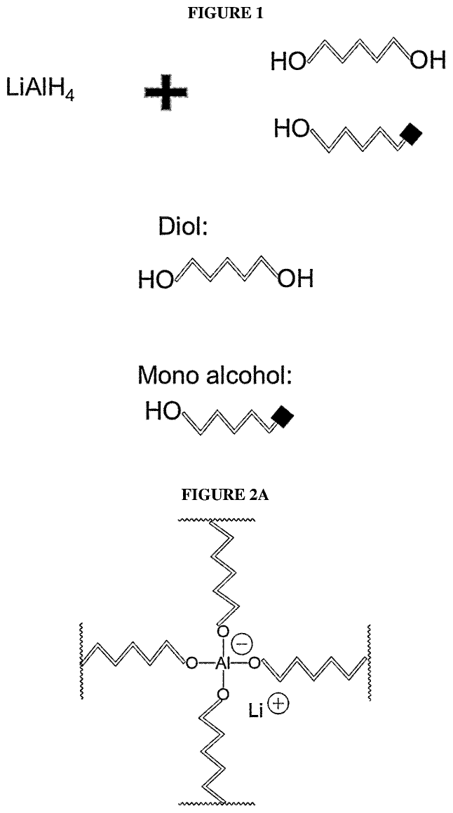

FIG. 1 illustrates a method according to some embodiments in which the compound of formula (I) is LiAlH₄; the second compound is a diol; and the third compound is a monohydric alcohol. The black square of FIG. 1 schematically illustrates group other than a hydroxyl at a chain end of a monohydric alcohol. This is an inert group which does not react with LiAlH₄ under the reaction conditions.

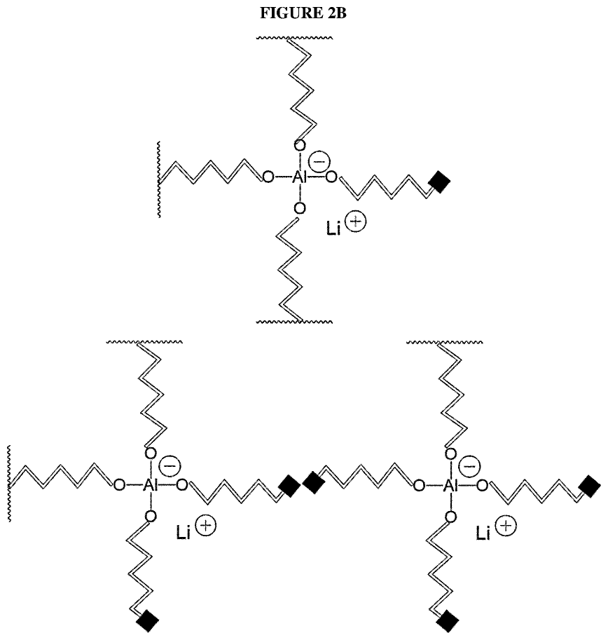

Upon reaction of the compound of formula (I) with a diol, an Al—O bond is formed to leave a hydroxyl group of the partially reacted diol which may then react with another Al atom to form a single-ion conductive network as illustrated in FIG. 2A.

Upon reaction of the compound of formula (I) with the monohydric alcohol, Al—O bonds are still formed, but no further reactions of the monohydric alcohol units occur in the absence of a second hydroxyl group.

Consequently, depending on the monohydric alcohol:diol molar ratio, only 1, 2 or 3 of the 4 O atoms of AlO₄⁻ are connected to another AlO₄⁻ through a linker group L formed from the diol as illustrated in in FIG. 2B.

The degree of interlinking between AlO₄⁻ centres within the network may therefore be controlled by selecting the number of reactive hydroxyl groups of the second compound and/or the second compound:third compound molar ratio.

The degree of interlinking may be controlled in order to obtain a single-ion conductive network of desired properties. Properties which may be changed as compared to a fully interlinked network include, without limitation, one or more of porosity, dynamic properties of the polymer, in particular dynamic properties of polymer segments, and mechanical strength.

These properties may in turn influence the ionic conductivity of the single-ion conductive network.

FIGS. 1 and 2 illustrate a single-ion conductive network formed from LiAlH₄, a monohydric alcohol and a diol, however it will be understood that single-ion conductive networks may be formed from other first, second and third materials as described herein.

The crosslinked ion-conducting network may comprise groups of formula (V):

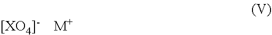

The network includes groups of formula (V) in which each one of the O atoms is bound through an organic linking group L to another group of formula (V); and
groups of formula (V) wherein at least one of the O atoms, optionally 1, 2 or 3 of the O atoms, is not bound through an organic linking group L to another group of formula (V).

Preferably, O atoms which are not bound to a group of formula (V) are bound to a group of formula (VI):

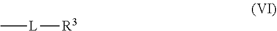

wherein R³ in each occurrence is independently H or F.

X is selected from Al and B.

M+ is a cation.

By “terminal C atom” of an alkyl group as used herein is meant a C atom of the methyl group or groups at the chain end or ends of a linear or branched alkyl, respectively.

Aluminium-oxygen bonds of a dynamic single-ion conductive network as described herein may break under mechanical stress, e.g. due to volume changes resulting from intercalation and release of metal cations from an electrode of a rechargeable battery containing the network. These bonds may be able to re-form, which may allow fissures or pin-holes in the dynamic single-ion conductive network to spontaneously close (self-heal) and thereby suppress metal dendrite formation.

### First Compound

Exemplary compounds of formula (I) include, without limitation, lithium aluminium hydride (LiAlH₄), lithium borohydride (LiBH₄) and lithium tetrahydrogallate (LiGaH₄).

The single-ion conductive network may contain only one of Al and B anions. The single-ion conductive network may contain both of Al and B anions.

### Second and Third Compounds

The second compound contains at least two hydroxyl groups. Preferably, the second compound contains only two hydroxyl groups.

The third compound contains only hydroxyl group.

Optionally, the second compound is a compound of formula (II):

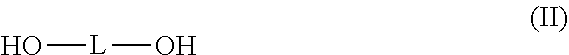

L is a divalent organic group.

Preferably, L is selected from groups of formula (IV):

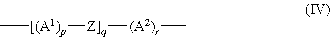

A¹ and A² in each occurrence are independently selected from: unsubstituted or substituted arylene; unsubstituted or substituted heteroarylene; and CR¹₂ wherein R¹ in each occurrence is H or a substituent.

q is 0 or a positive integer.

If q is a positive integer then p is at least 1.

In a preferred embodiment, q is at least 1, more preferably 1-6 and each A¹ is CR¹₂. According to these embodiments, p is preferably 2.

r is at least 1, preferably 1 or 2.

Z is O, S, NR⁴, Si(R⁵)₂SO₂, CO C═O, COO or CONR⁴ wherein R⁴ in each occurrence is independently H or a substituent and R⁵ in each occurrence is a substituent.

In a preferred embodiment, r is 1 and A² is an arylene or heteroarylene group.

In another preferred embodiment each A² is CR¹₂. According to these embodiments, r is preferably 2.

Preferably, R¹ in each occurrence is selected from:
H;
F; and
a linear, branched or cyclic alkyl, optionally a C₁₋₂₀ alkyl, wherein one or more non-adjacent, non-terminal C atoms may be replaced with O, S, NR⁴, Si(R⁵)₂SO₂, CO, COO or CONR⁴ and one or more H atoms may be replaced by F wherein R⁴ in each occurrence is independently H or a substituent and R⁵ in each occurrence is a substituent;
an anionic substituent; and
a photocrosslinkable group.

The presence of an anionic substituent R¹ may increase one or more of ionic conductivity of the network; solubility of the network in polar organic solvents or water; and adhesion as compared to a network in which the aluminate or borate groups formed following reaction of the compound of formula (I) are the only anionic groups of the network.

Exemplary anionic substituents are C₁₋₁₂ alkyl, aryl (e.g. phenyl) or C₁₋₁₂ alkylenearyl substituted with one or more anionic groups, wherein one or more non-adjacent, non-terminal C atoms of the C₁₋₁₂ alkyl or alkylene may be replaced with O, S, NR⁴, Si(R⁵)₂, SO₂, CO, COO or CONR⁴. The anionic substituent may be a sulfonate (—SO₃⁻) group or a substituent carrying one or more sulfonate groups, for example an alkylene sulfonate substituent. It will be understood that the charge of the anion is balanced with a cation M⁺ which is preferably the same as the cation M⁺ of formula (I), more preferably Li⁺.

The photocrosslinkable group may, following reaction of the first, second and third compounds, be crosslinked to increase the degree of crosslinking within the single-ion conductive network. Exemplary photocrosslinkable groups are groups comprising an azide.

Preferably, each R¹ is independently H or F.

A preferred arylene or heteroarylene group A¹ or A² is phenylene.

An arylene or heteroarylene group A¹ or A² may be unsubstituted or substituted with one or more substituents selected from F; CN; NO₂; and linear, branched or cyclic C₁₋₁₂ alkyl wherein one or more non-adjacent, non-terminal C atoms may be replaced with O or COO and one or more H atoms may be replaced by F.

Optionally, R⁴ in each occurrence is selected from H or a linear, branched or cyclic C₁₋₁₂ alkyl wherein one or more non-adjacent C atoms other than the C atom bound to N or a terminal C atom may be replaced with O, S, CO or COO and one or more H atoms may be replaced by F or an anionic group, e.g. SO₃⁻.

Each R⁴ is preferably selected from H or a linear, branched or cyclic C₁₋₁₂ alkyl wherein one or more non-adjacent C atoms other than the C atom bound to N or a terminal C atom may be replaced with O and one or more H atoms may be replaced by F.

Optionally, R⁵ in each occurrence is selected from H or a linear, branched or cyclic C₁₋₁₂ alkyl wherein one or more non-adjacent C atoms other than the C atom bound to Si or a terminal C atom may be replaced with O, S, CO or COO and one or more H atoms may be replaced by F or an anionic group, e.g. SO₃⁻.

Each R⁵ is preferably selected from H or a linear, branched or cyclic C₁₋₁₂ alkyl wherein one or more non-adjacent C atoms other than the C atom bound to Si or a terminal C atom may be replaced with O and one or more H atoms may be replaced by F.

Exemplary second compounds are diols, more preferably compounds of formula (IIa):

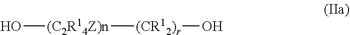

wherein:
Z is O, S, NR⁴, Si(R⁵)₂SO₂, CO C═O, COO or CONR⁴ wherein R⁴ and R⁵ are as described above; n is at least 1, optionally 1-6; r is at least 1, preferably 1 or 2; and each R¹, Z, R⁴ and R⁵ are as defined above.

Each R¹ is preferably H or F. Each Z is preferably O.

Exemplary compounds of Formula (IIa) include:

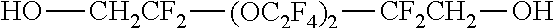

Optionally, the third compound is a compound of formula (III):

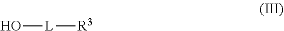

wherein L is as described above and R³ is selected from F and H.

Exemplary third compounds are compounds of formula (IIIa):

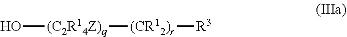

wherein q, r, Z and R¹ are as described above and R³ is H or F.

Exemplary compounds of Formula (IIIa) include:

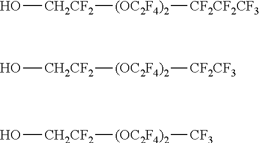

Optionally, the second compound:third compound molar ratio is in the range of 99:1-1:99.

In some embodiments, only one second compound is used. In some embodiments, two or more different second compounds are used.

In some embodiments, only one third compound is used. In some embodiments, two or more different third compounds are used.

### Silicate-Containing Single-Ion Conductive Networks

A single-ion conducting network containing silicate may be formed by reaction of a first compound of formula (VII) with a second compound and a third compound:

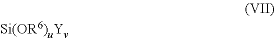

wherein R⁶ is an organic residue substituted with at least one group of formula -An⁻M⁺
wherein An⁻ is an anionic group and M⁺ is a cation;
Y is a leaving group, preferably a halide, more preferably Br, Cl, or I, most preferably Cl;
u is 1 or 2;
v is 4-u;
the second compound comprises at least two hydroxyl groups; and
the third compound comprises only one hydroxyl groups.

The second and third compounds may be as described anywhere herein.

It will be understood that the single-ion conducting network formed by this method may contain groups of formula SiOᵤYᵥ in which O atoms of this group are linked to other groups of formula SiOᵤYᵥ by an organic linker L and O atoms of this group are not linked to other groups of formula SiOᵤYᵥ.

R⁶ substituted with one or more groups An⁻M⁺ preferably has formula -L-(An⁻M⁺)_{w} wherein L is as described above and w is at least 1, preferably 1. An is preferably —SO₃⁻.

### Additive Compounds

In some embodiments, the single-ion conductive network may be formed from the first, second and third compounds only.

In some embodiments, the single-ion conductive network may comprise one or more further groups formed from reaction of one or more additive compounds.

The additive compounds may be selected from non-ionic compounds capable of reacting with the second and third compounds. The additive compound may be a silane, for example a silane substituted with groups selected from C₁₋₁₂ alkyl groups; C₁₋₁₂ alkoxy groups and halide groups wherein the silane is substituted with at least one halide group. An exemplary additive compound is tetrachlorosilane.

The identity and proportion of the additive compound or compounds may be selected to tune one or more properties of the single-ion conductive network, for example the degree of crosslinking and the surface properties, e.g. hydrophilicity, of the network.

### Applications

A single ion conducting material as described herein may be provided in a battery. The battery may be, without limitation, a metal battery or a metal ion battery, for example a lithium battery or a lithium ion battery.

The single ion conducting material may be a component of a composite comprising one or more additional materials. A layer comprising or consisting of single ion conducting material may be formed by depositing a formulation containing the material dissolved or dispersed in a solvent or solvent mixture followed by evaporation of the solvent or solvents.

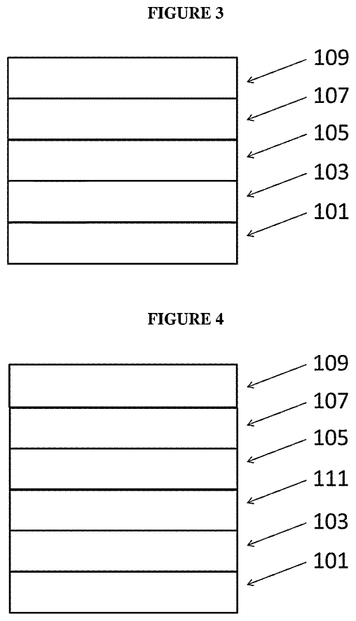

FIG. 3 illustrates a battery comprising an anode current collector 101 carrying an anode 103 on a surface thereof; a cathode current collector 109 having a cathode 107 disposed on a surface thereof; and a separator 105 disposed between the anode and cathode. The separator comprises or consists of a single-ion conductive network as described herein.

In the case of a metal battery, the anode is a layer of metal (e.g. lithium) which is formed over the anode current collector during charging of the battery and which is stripped during discharge of the battery.

In the case of a metal ion battery, the anode comprises an active material, e.g. graphite, for absorption of the metal ions.

The cathode may be selected from any cathode known to the skilled person.

The anode and cathode current collectors may be any suitable conductive material known to the skilled person, e.g. one or more layers of metal or metal alloy such as aluminium or copper.

FIG. 3 illustrates a battery in which the anode and cathode are separated only by a separator.

In other embodiments, one or more further layers may be disposed between the anode and the separator and/or the cathode and the separator.

FIG. 4 illustrates a battery, preferably a metal battery, comprising an anode current collector 101 carrying an anode 103 on a surface thereof; a cathode current collector 109 having a cathode 107 disposed on a surface thereof; a separator 105 disposed between the anode and cathode; and an anode protection layer 111 disposed between anode and the separator. The separator may comprise or consist of a single-ion conductive network as described herein or may be any other separator known to the skilled person, for example a porous polymer having a liquid electrolyte absorbed therein. The anode protection layer comprises or consist of a single-ion conductive network as described herein. The anode protection layer may prevent or retard formation of lithium metal dendrites of a metal battery.

In some embodiments, a single-ion conductive network may be used in a battery without any liquid electrolyte absorbed therein.

In some embodiments, an electrolyte is absorbed in the single-ion conductive network described herein.

The electrolyte may be an organic solvent or a blend of organic solvents. The solvent is optionally an alkyl carbonate or a mixture of organic carbonates, for example propylene carbonate, ethylene carbonate, dimethyl carbonate, ethylmethyl carbonate, fluoroethylene carbonate, vinylene carbonate, dimethoxyethane, diglyme, triglyme, tetraglyme, tetrahydrofuran, dioxolane, acetonitrile, adiponitrile, dimethylsulfoxide, dimethylformamide, nitromethane, N-methylpyrrolidone, ionic liquids, deep eutectic solvents and mixtures thereof.

A salt having a metal cation, may be dissolved in the electrolyte solvent, for example lithium bis(trifluoromethylsulfonyl)imide (LiTFSI) or lithium hexafluorophosphate Li bis(fluorosulfonyl)imide (LiFSI), LiAsF₆, LiSbF₆, LiClO₄, Li bisoxalatoborane, LiBF₄, LiNO₃, Li halides, Li dicyanamide and combinations thereof.

### Examples

410 mg of 1H, 1H, 11H,11H-perfluoro-3,6,9-trioxaundecane-1,11-diol (FTEG) was dissolved in 3 ml of THF together with 1, 5 or 10 wt % of fluorinated diethylene glycol monomethyl ether in a nitrogen glove box with <0.1 ppm of O₂ and H₂O.

Under nitrogen and under continuous stirring 500, 520 and 540 microlitres of 1M solution of LiAlH₄ in THF were added dropwise to the solutions with, respectively, 1, 5 and 10 wt % of fluorinated diethylene glycol monomethyl ether. The mixture was left overnight.

The solution was then spun onto copper foil, in a nitrogen-filled glovebox—to obtain a layer with a thickness ranging between 100 and 200 nm.

1. A method of forming a single-ion conductive network comprising reaction of a first compound of formula (I) with a second compound and a third compound: 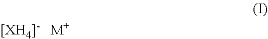
wherein X is selected from the group consisting of B and Al;
M⁺ is a cation;
the second compound comprises at least two hydroxyl groups; and
the third compound comprises only one hydroxyl group.

2. The method according to claim 1 wherein M⁺ is Li⁺.

3. The method according to claim 1 wherein the second compound is a compound of formula (II): 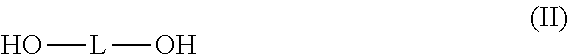
wherein L is a divalent organic group.

4. The method according to claim 1 wherein the third compound is a compound of formula (III): 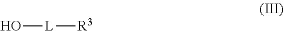
wherein L is a divalent organic group; and R³ is selected from F and H.

5. The method according to claim 3 wherein L is a group of formula (IV): 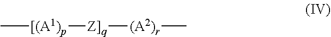
wherein:
A¹ and A² in each occurrence are independently selected from unsubstituted or substituted arylene; unsubstituted or substituted heteroarylene; and CR¹₂ wherein R¹ in each occurrence is H or a substituent;
q is 0 or a positive integer;
if q is a positive integer then p is at least 1; and
r is at least 1; and
Z in each occurrence is independently O, S, NR⁴, Si(R⁵)₂SO₂, CO C═O, COO or CONR⁴ wherein R⁴ in each occurrence is independently H or a substituent and R⁵ in each occurrence is a substituent.

6. The method according to claim 5 wherein each R¹ is independently selected from the group consisting of:
H;
F;
a linear, branched or cyclic C₁₋₁₂ alkyl wherein one or more non-adjacent, non-terminal C atoms may be replaced with O or COO and one or more H atoms may be replaced by F;
an anionic group; and
a photocrosslinkable group.

7. The method according to claim 6 wherein each R¹ is independently H or F.

8. The method according to claim 1 wherein the second compound is a dihydric alcohol.

9. The method according to claim 3 wherein the second compound is a compound of formula (IIa): 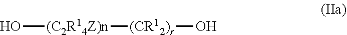
wherein R¹ in each occurrence is H or a substituent; n is at least 1; r is at least 1; and Z in each occurrence is independently O, S, NR⁴, Si(R⁵)₂SO₂, CO C═O, COO or CONR⁴ wherein R⁴ in each occurrence is independently H or a substituent and R⁵ in each occurrence is a substituent.

10. The method according to claim 4 wherein the third compound is a compound of formula (IIIa): 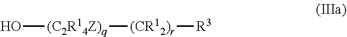
wherein:
R¹ in each occurrence is H or a substituent;
q is at least 1;
r is at least 1; and
Z in each occurrence is independently O, S, NR⁴, Si(R⁵)₂SO₂, CO C═O, COO or CONR⁴ wherein R⁴ in each occurrence is independently H or a substituent and R⁵ in each occurrence is a substituent.

11. The method according to claim 1 wherein the second compound:third compound molar ratio is between 99:1-1:99.

12. A single ion-conducting network obtainable by the method according to claim 1.

13. A single ion-conducting network comprising groups of formula (V): 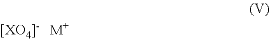
wherein: X is selected from Al and B; M⁺ is a cation; and wherein the single-ion conducting network includes groups of formula (V) wherein at least one of the O atoms is bound through an organic group L to an O atom of another group of formula (V) and at least one of the O atoms is bound to an organic group which is not bound to another group of formula (V).

14. The single ion-conducting network according to claim 13 further comprising groups of formula (V) in which each one of the O atoms of formula (V) groups is bound through an organic linking group L to an O atom of another group of formula (V).

15. The single ion-conducting network according to claim 13 wherein the organic group which is not bound to another group of formula (V) is a group of formula (VI): 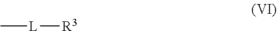
wherein R³ in each occurrence is independently H or F.

16. The single-ion conducting network according to claim 13 wherein L is a group of formula (IV): 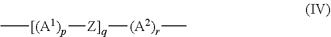
wherein:
A¹ and A² in each occurrence are independently selected from unsubstituted or substituted arylene; unsubstituted or substituted heteroarylene; and CR¹₂ wherein R¹ in each occurrence is H or a substituent;
q is 0 or a positive integer;
if q is a positive integer then p is at least 1;
r is at least 1; and
Z in each occurrence is independently O, S, NR⁴, Si(R⁵)₂SO₂, CO C═O, COO or CONR⁴ wherein R⁴ in each occurrence is independently H or a substituent and R⁵ in each occurrence is a substituent.

17. A metal battery or metal ion battery comprising an anode, a cathode and a structure comprising a single-ion conducting network according to claim 12 disposed between the anode and cathode.

18. The metal battery or metal ion battery according to claim 17 wherein the structure comprises the single-ion conducting network and an additional material.

19. The metal battery or metal ion battery according to claim 18 wherein the additional material is an organic polymer dispersed in the single-ion conducting network.

20. (canceled)

21. A method of forming a single-ion conductive network comprising reaction of a first compound of formula (VII) with a second compound and a third compound: 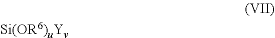
wherein R⁶ is an organic residue substituted with at least one group of formula -An⁻M⁺
wherein An⁻ is an anionic group and M⁺ is a cation;
Y is a leaving group;
u is 1 or 2;
v is 4-u;
the second compound comprises at least two hydroxyl groups; and
the third compound comprises only one hydroxyl group.
